(19) United States
(12) Patent Application Publication
(10) Pub. No.: US 2025/0192840 A1
(43) Pub. Date: Jun. 12, 2025

(54) METHOD AND APPARATUS FOR ENHANCING PERFORMANCE OF USER EQUIPMENT IN A WIRELESS COMMUNICATION SYSTEM

(71) Applicant: Samsung Electronics Co., Ltd., Suwon-si (KR)

(72) Inventor: Amod Ashok CHOURASIA, Noida (U.P.) (IN)

(21) Appl. No.: 18/747,097

(22) Filed: Jun. 18, 2024

Related U.S. Application Data
(63) Continuation of application No. PCT/KR2024/005413, filed on Apr. 22, 2024.

(30) Foreign Application Priority Data
Dec. 12, 2023 (IN) 202311084797

(51) Int. Cl. H04B 7/06; H04B 17/309; H04B 17/391

(52) U.S. Cl. CPC H04B 7/0626; H04B 7/0632; H04B 17/346; H04B 17/3913

(57) ABSTRACT

The disclosure relates to a 5G or 6G communication system supporting a higher data transmission rate. A method includes: determining a plurality of physical characteristics associated with the UE for at least one of an indoor and/or outdoor environment; configuring a measurement process for at least one wireless communication channel based on the plurality of determined physical characteristics; generating a CSI feedback based on the configured measurement process and a characteristic of the at least one wireless communication channel; applying the generated CSI feedback to perform model inference with potential adjustments of one or more wireless communication parameters; determining the CQI based on the generated CSI feedback and the configured measurement process; and applying the potential adjustments of the one or more wireless communication parameters of the UE to enhance the performance of the UE 100, based on the determined CQI and the plurality of determined physical characteristics.

### CROSS-REFERENCE TO RELATED APPLICATIONS

This application is a continuation of International Application No. PCT/KR2024/005413 designating the United States, filed on Apr. 22, 2024, in the Korean Intellectual Property Receiving Office and claiming priority to Indian Patent Application No. 202311084797, filed on Dec. 12, 2023, in the Indian Patent Office, the disclosures of each of which are incorporated by reference herein in their entireties.

### BACKGROUND

### Field

The disclosure relates to the field of wireless communication systems. For example, the disclosure relates to a method, an apparatus and a system for enhancing a performance of a User Equipment (UE) in a wireless communication system.

### Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Currently, there is a need to enhance a performance of terminal (or, user equipment, UE) in a wireless communication system.

### SUMMARY

According to an example embodiment of the present disclosure, a method for enhancing a performance of a User Equipment (UE) in a wireless communication system is disclosed herein. The method includes: determining a plurality of physical characteristics associated with the UE for at least one of an indoor environment and an outdoor environment; configuring a measurement process for at least one wireless communication channel based on the plurality of determined physical characteristics; generating a Channel State Information (CSI) feedback based on the configured measurement process and a characteristic of the at least one wireless communication channel; and applying the generated CSI feedback to perform model inference with potential adjustments of one or more wireless communication parameters to enhance the performance of the UE utilizing an Artificial Intelligence (AI) module of the UE.

According to an example embodiment of the present disclosure, a user equipment (UE) for enhancing the performance of the UE in the wireless communication system is disclosed. The UE includes a system, wherein the system may include: a parameter adjustment module coupled with a memory, at least one processor, comprising processing circuitry, and a communicator, comprising communication circuitry. The parameter adjustment module may be configured to: determine the plurality of physical characteristics associated with the UE for at least one of the indoor environment and the outdoor environment; configure the measurement process for the at least one wireless communication channel based on the plurality of determined physical characteristics; generate a channel state information (CSI) feedback based on the configured measurement process and the characteristics of the at least one wireless communication channel; and apply the generated CSI feedback to perform model inference with the potential adjustments of the one or more wireless communication parameters for enhancing the performance of the UE utilizing an artificial intelligence (AI) module, comprising processing circuitry, of the UE.

To further clarify the advantages and features of the present disclosure, a more detailed description will be rendered with reference to various example embodiments thereof, which are illustrated in the appended drawings. It is appreciated that these drawings depict example embodiments and are therefore not to be considered limiting of its scope.

### BRIEF DESCRIPTION OF THE DRAWINGS

These and other features, aspects, and advantages of certain embodiments of the present disclosure will be more apparent from the following detailed description, taken in conjunction with the accompanying drawings in which like characters represent like parts throughout the drawings, an in which:

FIG. 1 is a signal flow diagram illustrating one or more measurement processes of existing wireless communication systems, according to the prior art;

FIG. 2A is a diagram illustrating an example scenario in which a User Equipment (UE) sends a measurement report to a base station while in motion, according to the prior art;

FIG. 2B is a diagram illustrating another example scenario in which the UE sends the measurement report to the base station while in motion, according to the prior art;

FIG. 2C is a diagram illustrating a time difference between CSI requested and network allocated resources introducing performance issues in the UE during mobility, according to the prior art;

FIG. 3A is a block diagram illustrating an example configuration of a User Equipment (UE) for enhancing a performance of the UE in terms of one or more measurement processes in a wireless communication system, according to various embodiments;

FIG. 3B is a diagram illustrating an example configuration of a parameter adjustment module of the UE for enhancing a performance of the UE in terms of the one or more measurement processes in the wireless communication system, according to various embodiments;

FIG. 3C is a signal flow diagram illustrating one or more measurement processes performed by the UE to enhance the performance, according to various embodiments;

FIG. 4 is a diagram illustrating an example scenario where an Artificial Intelligence (AI) module of the UE performs one or more operations for generating Channel State Information (CSI) feedback and/or predicted CSI image information based on a configured measurement process and a characteristic of at least one wireless communication channel, according to various embodiments;

FIG. 5 is a diagram illustrating an example scenario where the AI module of the UE performs one or more operations for applying the generated CSI feedback to perform model inference with potential adjustments of one or more wireless communication parameters for enhancing the performance of the UE, according to various embodiments;

FIG. 6A is a diagram illustrating an example scenario in which the UE sends a measurement report to a base station while in motion by utilizing the parameter adjustment module of the UE, according to various embodiments;

FIG. 6B is a diagram illustrating another example scenario in which the UE sends the measurement report to the base station while in motion by utilizing the parameter adjustment module of the UE, according to various embodiments;

FIG. 7 is a flowchart illustrating an example method for enhancing the performance of the UE in the wireless communication system, according to various embodiments;

FIG. 8 is a block diagram illustrating an example configuration of a user equipment (UE or terminal) according to various embodiments; and

FIG. 9 is a block diagram illustrating an example configuration of a base station (BS) according to various embodiments.

Further, skilled artisans will appreciate that elements in the drawings are illustrated for simplicity and may not have necessarily been drawn to scale. For example, the flowchart illustrate the method in terms of steps involved to help to improve understanding of aspects of the present disclosure. Furthermore, in terms of the construction of the device, one or more components of the device may have been represented in the drawings by conventional symbols, and the drawings may illustrate those specific details that are pertinent to understanding the embodiments of the present disclosure so as not to obscure the drawings with details that will be readily apparent to those of ordinary skill in the art having the benefit of the description herein.

### DETAILED DESCRIPTION

For the purpose of promoting an understanding of the principles of the disclosure, reference will now be made to various example embodiments illustrated in the drawings and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are explanatory of the disclosure and are not intended to be restrictive thereof.

Reference throughout this disclosure to “an aspect”, “another aspect” or similar language may refer, for example, to a particular feature, structure, or characteristic described in connection with an embodiment being included in at least one embodiment of the present disclosure. Thus, appearances of the phrase “in an embodiment”, “in one embodiment”, “in another embodiment”, and similar language throughout this disclosure may, but do not necessarily, all refer to the same embodiment.

The terms “comprise”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The various example embodiments described herein are not necessarily mutually exclusive, as various embodiments can be combined with various embodiments to form new embodiments. The term “or” as used herein, refers to a non-exclusive or unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the disclosure herein.

Various example embodiments may be described and illustrated in terms of blocks that carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits of a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the invention. Likewise, the blocks of the embodiments may be physically combined into more complex blocks without departing from the scope of the invention.

The accompanying drawings are used to aid in easily understanding various technical features and it should be understood that the embodiments presented herein are not limited by the accompanying drawings. As such, the present disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

In wireless communication systems, signal quality is a critical factor that affects an overall user experience. As a user moves around, the signal quality can be impacted by various factors such as distance, obstacles, and multipath fading. These factors can cause signal strength to weaken, resulting in signal attenuation and signal fluctuation, which can lead to, for example, degraded quality calls, low data speeds, and freezing video streaming. For instance, the user is streaming a High-Definition (HD) video on a User Equipment (UE) while moving from an outdoor environment (such as, a park) to an indoor environment (such as, a building). As the user enters the building, the signal strength between the associated UE and a connected base station weakens due to obstruction caused by walls and other structures of the building. The signal attenuation caused by obstacles, as well as multipath fading due to signal reflections, results in weakened signal strength and poor connectivity between the associated UE of the user and the base station resulting in delayed streaming of the HD video/degrading quality of the HD video/freezing streaming of the HD video. In another instance, assuming multiple users are playing an online multiplayer game on the corresponding UEs while traveling on a train. As the train moves through different areas with varying signal conditions, the signal quality fluctuates rapidly leading to interruptions, delays, and lag in the online multiplayer game. Such scenarios impact the overall user experience with the wireless communication system. Additionally, the demand for bandwidth is increasing rapidly as more users are using their electronic devices for data-intensive applications such as video streaming, online gaming, and file downloads. This increased demand can lead to network congestion and further degrade a quality of communication (e.g., voice call, video call, etc.) of the wireless communication systems.

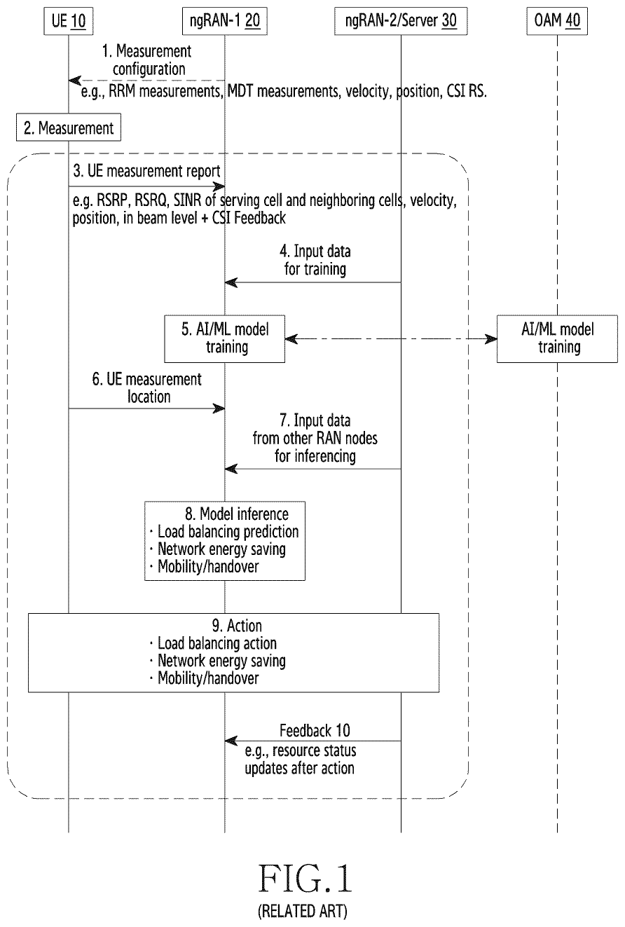

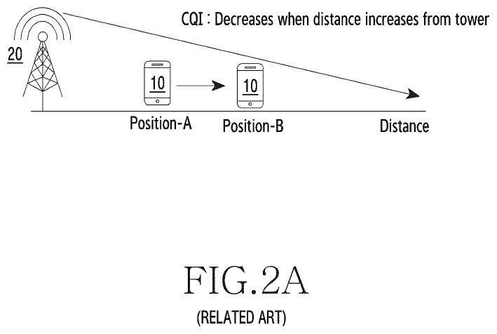

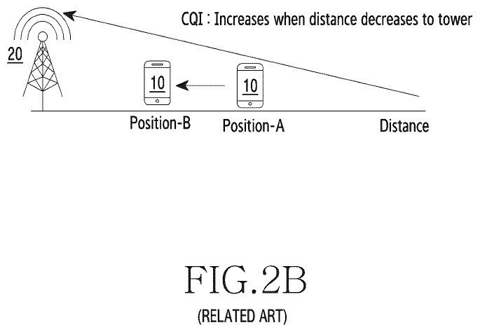

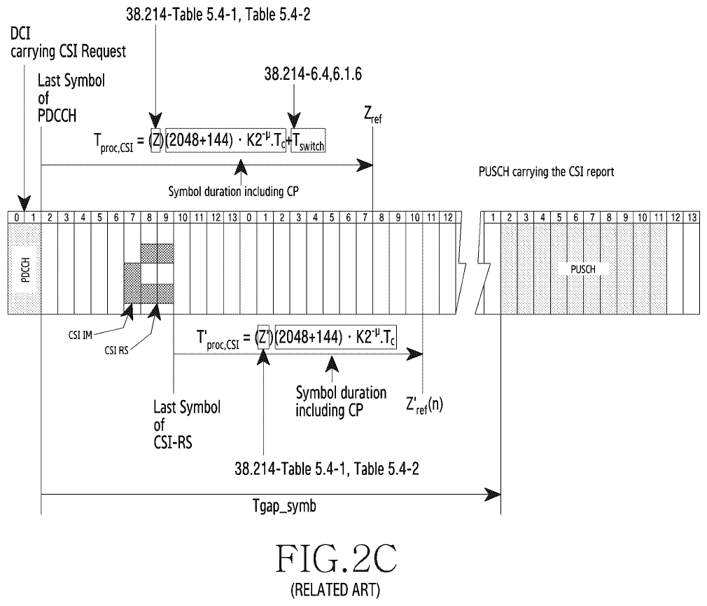

To address these challenges, the existing wireless communication systems (e.g., 4^{th} Generation (4G) wireless communication system, 5^{th} Generation (5G) wireless communication system, etc.) use measurement processes that involve the electronic device (e.g., the UE) and network devices (e.g., base station or gNB) exchanging information about the communication quality. This information includes a Channel State Information (CSI) feedback and a Channel Quality Indicator (CQI) report. The UE measures the quality of the received signal and sends the measured information to the network device. The network device uses the received information to adjust the transmission parameters (such as power, modulation, and coding) to optimize the communication quality by utilizing one or more Artificial intelligence (AI) models at the network device, as illustrated in FIG. 1. However, these measurement processes has some limitations that need to be addressed in order to provide better communication quality, as described in conjunction with FIG. 1, FIG. 2A, FIG. 2B, and FIG. 2C.

FIG. 1 is a signal flow diagram illustrating various measurement processes of the existing wireless communication systems, according to the prior art. The existing wireless communication systems may include a UE 10, a base station (e.g., Next Generation Radio Access Network (ngRAN)-1) 20, other base station (ngRAN-2/server 30), and an Operations, Administration, and Maintenance (OAM) 40.

At step-1, the UE 10 receives information (measurement configuration) from the ngRAN-1 20 regarding the measurements that needs to perform. The received information includes various types of measurements such as Radio Resource Management (RRM) measurements, Mobility Data Tracking (MDT) measurements, velocity, position, and Channel State Information Reference Signal (CSI-RS). At step-2, upon receiving the measurement configuration information, the UE 10 starts one or more measurement processes as instructed by the ngRAN-1 20. The one or more measurement processes involve collecting data related to the RRM measurements, MDT measurements, velocity, position, and CSI feedback. At step-3, the UE 10 sends a measurement report to the ngRAN-1 20. The measurement report includes important parameters such as Reference Signal Received Power (RSRP), Reference Signal Received Quality (RSRQ), and Signal-to-Interference-plus-Noise Ratio (SINR) for both the serving cell and neighboring cells. Additionally, the report may also include velocity, position, and in-beam level and CSI Feedback.

At step-4, the ngRAN-1 20 receives input data from other base station (ngRAN-2 30/server) for training purposes. The received input data is used to improve the performance of an Artificial Intelligence/Machine Learning (AI/ML) model associated with the ngRAN-1 20. At step-5, the ngRAN-1 20 trains its AI/ML model by communicating with an AI/ML model of the OAM 40. This training process enhances the ability of the ngRAN-1 20 to make accurate predictions and decisions. At step-6 to 10, after training, when the ngRAN-1 20 receives measurement location data from the UE 10 and input data from other base station (ngRAN-2 30/server) for inferencing, the ngRAN-1 20 performs one or more actions and model inferences. The one or more actions and model inferences are related to various tasks such as load balancing prediction, network energy saving, mobility/handover management, and resource allocation for optimizing network performance. However, the one or more measurement processes of the existing wireless communication systems may also have a few problems. One of such problems is that the current measurement processes rely on training that happens solely at the base station and/or operator level. This approach can be time-consuming, as described in conjunction with FIG. 2C, needs extensive signal processing, overhead, and resources, resulting in higher power consumption and lower network capacity. Additionally, it does not allow for real-time decision-making associated with the UE 10 when it is in motion in indoor or outdoor environments, as described in conjunction with FIG. 2A and FIG. 2B.

FIG. 2A is a diagram illustrating an example scenario in which the UE 10 sends the measurement report to the base station 20 while in motion, according to the prior art. Consider a scenario where the UE 10 starts moving away from the connected base station 20. As the distance between the UE 10 and the base station 20 increases, the SINR value decreases. Consequently, the CSI feedback value, for example the CQI, also reduces with increasing distance. In this scenario, at a position-A, the UE 10 receives CSI feedback, and the UE 10 takes some time (t) to calculate the CSI feedback value, as described in conjunction with FIG. 2C. Once the CSI feedback value is calculated, the UE 10 sends the CQI value to the connected base station 20. Based on this CQI value, the connected base station 20 makes decisions regarding resource allocations to UE 10. However, all the resource allocations by the base station 20 are based on the UE's CSI feedback at the position-A. The problem arises when the UE 10 moves from the position-A to a position-B before the connected base station 20 can allocate resources. As the UE 10 moves to the position-B, the network conditions become even worse, which may refer, for example, to the UE's experience deteriorating. This deterioration in user experience is undesirable and can be attributed to the fact that the resource allocation was based on outdated CSI feedback from the position-A.

FIG. 2B is a diagram illustrating another example scenario in which the UE 10 sends the measurement report to the base station 20 while in motion, according to the prior art. Consider a scenario where the UE 10 starts moving towards the connected base station 20. As the distance between the UE 10 and the base station 20 decreases, the SINR value increases. Consequently, the CSI feedback value, specifically the CQI, also increases with decreasing distance. In this scenario, at the position-A, the UE 10 receives CSI feedback, and the UE 10 takes some time (t) to calculate the CSI feedback value, as described in conjunction with FIG. 2C. Once the CSI feedback value is calculated, the UE 10 sends the CQI value to the connected base station 20. Based on this CQI value, the connected base station 20 makes decisions regarding resource allocation. However, all these resource allocations are based on the UE's CSI feedback at position-A. The problem arises when the UE 10 moves from the position-A to the position-B before the connected base station 20 can allocate resources. As the UE 10 moves to the position-B, the network conditions become better, but the resource allocation was based on outdated CSI feedback from the position-A, which may refer, for example, to the UE's experience deteriorating.

FIG. 2C is a diagram illustrating a time difference (e.g., t) between CSI requested and network allocated resources introducing performance issues in the UE 10 during mobility, according to the prior art.

When the UE 10 receives information on a Physical Uplink Shared Channel (PUSCH), the UE 10 has the option to provide feedback (CSI feedback) for an n^{th}-triggered report. However, this feedback is only provided if a first uplink symbol that carries the corresponding CSI report(s), taking into account the timing advance effect, starts no earlier than symbol Z_{ref}.

If the n^{th} CSI report including the effect of the timing advance, starts no earlier than at symbol Z′ref(n), where Zref is defined as the next uplink symbol with associated Cyclic Prefix (CP) starting T_{proc,CSI}=(Z)(2048+144)·κ2^{-μ}·T_{c}+T_{switch} after the end of the last symbol of the PDCCH triggering the CSI report(s), and where Z′ref(n), is defined as the next uplink symbol with its CP starting T′_{proc,CSI}=(Z′)(2048+144)·κ2^{-μ}·T_{c} after the end of the last symbol. Here, Z, Z′, and p are defined as,

$$Z = {max}_{m = 0 , … , M - 1} ( Z ( m ) ) and {Z}^{′} = {max}_{m = 0 , … , M - 1} ( {Z}^{′} ( m ) ) ,$$

where M is the number of updated CSI report(s), for example, as described in Table-1A and Table-1B below.

TABLE 1A

Z₁ [symbols]

| μ | Z₁ | Z′₁ |
|---|---|---|
| 0 | 10 | 8 |
| 1 | 13 | 11 |
| 2 | 25 | 21 |
| 3 | 43 | 36 |

TABLE 1B

| | Z₁ [symbols] | | Z₂ [symbols] | | Z₃ [symbols] | |
|---|---|---|---|---|---|---|
| | Z₁ | Z′₁ | Z₂ | Z′₂ | Z₃ | Z′₃ |
| 0 | 22 | 16 | 40 | 37 | 22 | X₀ |
| 1 | 33 | 30 | 72 | 69 | 33 | X₁ |
| 2 | 44 | 42 | 141 | 140 | min(44, X₂ + KB₁) | X₂ |
| 3 | 97 | 85 | 152 | 140 | min(97, X₃ + KB₂) | X₃ |
| 5 | 388 | 340 | 608 | 560 | min(388, X5 + KB3) | X5 |
| 6 | 776 | 680 | 1216 | 1120 | min(776, X6 + KB4) | X6 |

Further, existing positioning methods, such as time difference of arrival (TDOA), have limitations when it comes to accuracy in non-line-of-sight conditions. These methods do not effectively utilize multipath data, which can impact the accuracy of the positioning results associated with the UE. As a result, in challenging environments where there are obstacles or signal reflections, the accuracy of these classical methods may be compromised. On the other hand, current ML methods, like RF fingerprinting (RFFP), offer higher accuracy in positioning. These ML methods leverage advanced algorithms and techniques to analyze radio frequency (RF) signals and create unique fingerprints for different locations. This enables accurate positioning even in complex environments. However, the ML methods like RFFP have their limitations. They require a large number of labeled data points for training the model. This may refer, for example, to extensive manual labeling of data being needed, which can be time-consuming and resource-intensive. Additionally, ML methods may lack robustness in changing environments, where the RF characteristics and signal propagation conditions vary over time.

Thus, it is desired to address the above-mentioned disadvantages or other shortcomings or at least provide a useful alternative for enhancing the performance of the UE in the wireless communication systems.

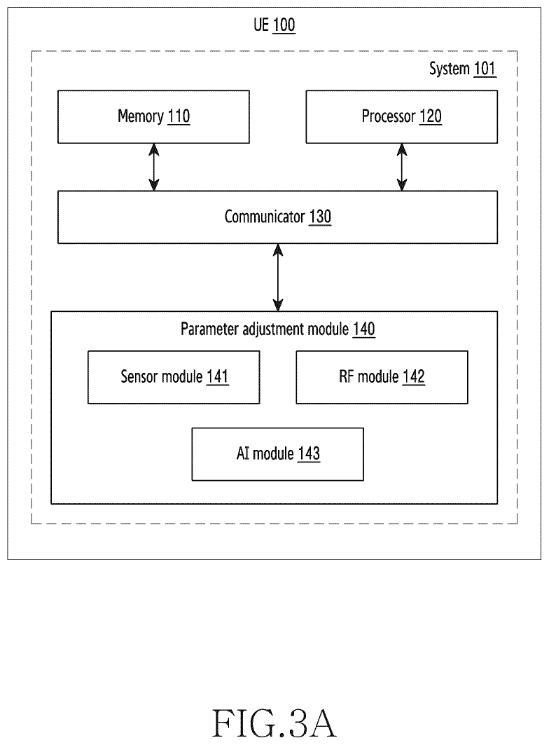

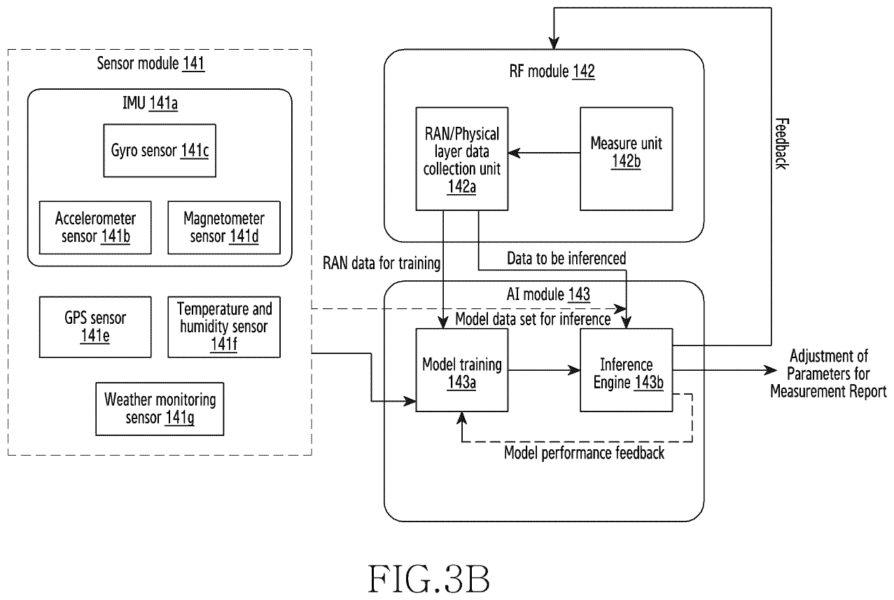

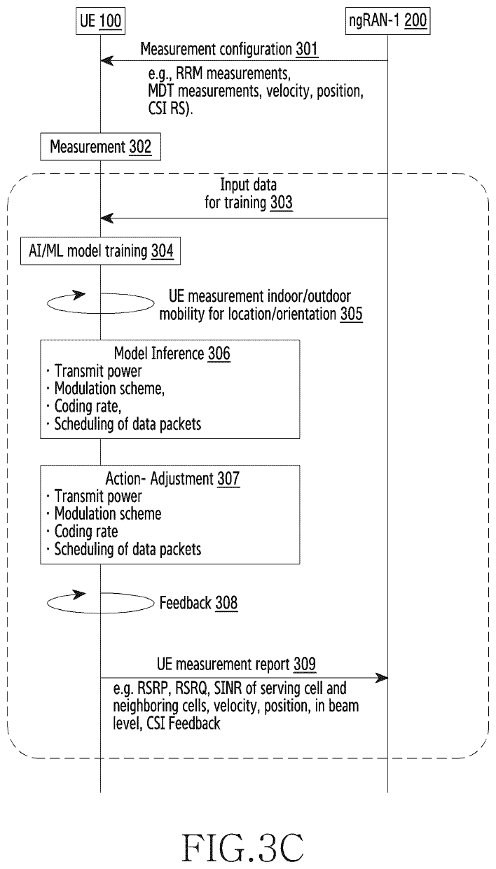

Referring now to the drawings, and more particularly to FIGS. 3A to 9, where similar reference characters denote corresponding features throughout the figures, there are shown various example embodiments.

FIG. 3A is a block diagram illustrating an example configuration of a User Equipment (UE) 100 for enhancing a performance of the UE 100 in terms of one or more measurement processes in a wireless communication system, according to various embodiments. Examples of the UE 100 include, but are not limited to a smartphone, a tablet computer, a Personal Digital Assistance (PDA), an Internet of Things (IoT) device, a wearable device, etc.

In an embodiment, the UE 100 comprises a system 101. The system 101 may include a memory 110, a processor (e.g., including processing circuitry) 120, a communicator (e.g., including communication circuitry) 130, and a parameter adjustment module (e.g., including various circuitry) 140.

In an embodiment, the memory 110 stores instructions to be executed by the processor 120 for enhancing the performance of the UE 100 in the wireless communication system (e.g., 4^{th} Generation (4G) wireless communication system, 5^{th} Generation (5G) wireless communication system, etc.), as discussed throughout the disclosure. The memory 110 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 110 may, in some examples, be considered a non-transitory storage medium. The term “non-transitory” may indicate that the storage medium is not embodied in a carrier wave or a propagated signal. However, the term “non-transitory” should not be interpreted that the memory 110 is non-movable. In some examples, the memory 110 can be configured to store larger amounts of information than the memory. In certain examples, a non-transitory storage medium may store data that can, over time, change (e.g., in Random Access Memory (RAM) or cache). The memory 110 can be an internal storage unit, or it can be an external storage unit of the UE 100, a cloud storage, or any other type of external storage.

The processor 120 communicates with the memory 110, the communicator 130, the display (140), the camera (150), and the image processing engine (160). The processor 120 is configured to execute instructions stored in the memory 110 and to perform various processes for enhancing the performance of the UE 100 in the wireless communication system, as discussed throughout the disclosure. The processor 120 may include one or a plurality of processors, maybe a general-purpose processor, such as a central processing unit (CPU), an application processor (AP), or the like, a graphics-only processing unit such as a graphics processing unit (GPU), a visual processing unit (VPU), and/or an Artificial Intelligence (AI) dedicated processor such as a neural processing unit (NPU). The processor 120 according to an embodiment of the disclosure may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The communicator 130 may include various communication circuitry and is configured for communicating internally between internal hardware components and with external devices (e.g., server) via one or more networks (e.g., Radio technology). The communicator 130 includes an electronic circuit specific to a standard that enables wired or wireless communication.

In various embodiments, the parameter adjustment module 140 may implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

In various embodiments, the parameter adjustment module 140 may include a sensor module (e.g., including at least one sensor) 141, a Radio Frequency (RF) module (e.g., including RF circuitry) 142, and an Artificial Intelligence (AI) module (e.g., including AI circuitry) 143.

In various embodiments, the sensor module 141 may determine a plurality of physical characteristics associated with the UE 100 for at least one of an indoor environment and an outdoor environment, as described in greater detail below with reference to FIG. 3B. The sensor module 141 may include, but is not limited to, an accelerometer sensor, a gyro sensor, a magnetometer sensor, a Global Positioning System (GPS) sensor, a temperature and humidity sensor, and a weather monitoring sensor. The plurality of physical characteristics may include, but are not limited to, a UE distribution in a particular cell associated with the wireless communication system, a carrier frequency, a speed of the UE 100, a location of the UE 100, an orientation of the UE 100, a movement of the UE 100, and a Channel Quality Indicator (CQI).

In various embodiments, the RF module 142 may configure a measurement process for at least one wireless communication channel based on the plurality of determined physical characteristics. Further, the RF module 142 may generate a Channel State Information (CSI) feedback based on the configured measurement process and a characteristic of the at least one wireless communication channel, as described in greater detail below with reference to FIG. 3B and FIG. 3C. The RF module 142 may execute multiple steps for the measurement process and/or to generate CSI feedback, which are given below.

In various embodiments, the RF module 142 may receive a request from a network device (e.g., base station, eNB, etc.) to perform one or more measurements associated with the at least one wireless communication channel. The one or more measurements may include, but are not limited to, a Radio Resource Management (RRM) measurements, Minimization of Drive Tests (MDT) measurements, a speed of the UE 100, a position of the UE 100, a Channel State Information Reference Signal (CSI RS), a CSI measurement, and a Signal-to-Interference-plus-Noise Ratio (SINR). The CSI measurement may include, but is not limited to, different types of CSI, the different types of CSI comprise at least one of a Channel Quality Indicator (CQI), a Precoding Matrix Indicator (PMI), a CSI-RS Resource Indicator (CRI), a SS/PBCH Resource Block Indicator (SSBRI), a Layer Indicator (LI), and a Rank Indicator (RI). Further, the RF module 142 may send a report associated with the one or more performed measurements to the network device, where the CSI measurement is reported to the network device either periodically, aperiodically, or in a semi-persistent manner within a time domain.

In various embodiments, the RF module 142 may receive Radio Resource Control (RRC) configuration information from the network device. The RF module 142 may configure a CSI-reporting may include, but are not limited to, a CSI-RS resource mapping, a CSI informational measurement resource, a CSI semi-persistent on Physical Uplink Shared Channel (PUSCH) trigger state list, a CSI aperiodic trigger state list, a CSI resource configuration, and a CSI report configuration.

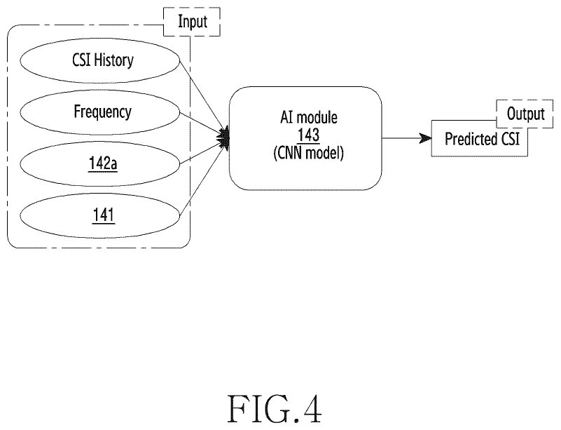

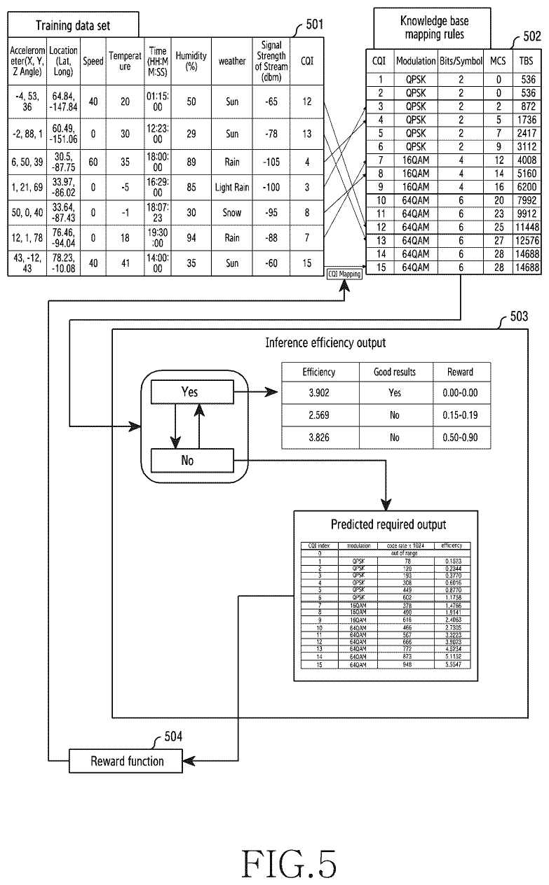

In various embodiments, the AI module 143 may apply the generated CSI feedback to perform model inference with potential adjustments of one or more wireless communication parameters for enhancing the performance of the UE 100. Further, the AI module 143 may determine the CQI based on the generated CSI feedback and the configured measurement process. Furthermore, the AI module 143 may apply the potential adjustments of the one or more wireless communication parameters of the UE 100 to enhance the performance of the UE 100, based on the determined CQI and the plurality of determined physical characteristics, as described in greater detail below with reference to FIG. 3B, FIG. 3C, FIG. 4, and FIG. 5. The one or more wireless communication parameters may include, but are not limited to, an optimal transmission power, an optimal Modulation and Coding Scheme (MCS), an optimal coding rate, scheduling of data packets, a Transport Block Size (TBS), and a Resource Block (RB).

A function associated with the various components of the UE 100 may be performed through the non-volatile memory, the volatile memory, and the processor 120. One or a plurality of processors controls the processing of the input data in accordance with a predefined operating rule or AI model stored in the non-volatile memory and the volatile memory. The predefined operating rule or AI model is provided through training or learning. Here, being provided through learning may refer, for example, to, by applying a learning algorithm to a plurality of learning data (plurality of physical characteristics), a predefined operating rule or the AI module 143 of the desired characteristic being made. The learning may be performed in the UE 100 itself in which AI according to an embodiment is performed, and/or may be implemented through a separate server/system. The learning algorithm may include a method for training a predetermined target device (for example, a smartphone) using a plurality of learning data to cause, allow, or control the target device to decide or predict. Examples of learning algorithms include, but are not limited to, supervised learning, unsupervised learning, semi-supervised learning, or reinforcement learning.

The AI module 143 may include a plurality of neural network layers. Each layer has a plurality of weight values and performs a layer operation through a calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

Although FIG. 3A shows various hardware components of the UE 100, it is to be understood that various embodiments are not limited thereon. In various embodiments, the UE 100 may include less or more number of components. Further, the labels or names of the components are used only for illustrative purposes and do not limit the scope of the invention. One or more components can be combined to perform the same or substantially similar functions to enhance the performance of the UE 100 in the wireless communication system.

FIG. 3B is a diagram illustrating an example configuration of the parameter adjustment module 140 of the UE 100 for enhancing the performance of the UE 100 in terms of the one or more measurement processes in the wireless communication system, according to various embodiments. The parameter adjustment module 140 may include the sensor module 141, the RF module 142, and the AI module 143. The sensor module 141 may include an Inertial Measurement Unit (IMU) 141a, a GPS sensor 141e, a temperature and humidity sensor 141f, and a weather monitoring sensor 141g.

In various embodiments, an Inertial Measurement Unit (IMU) 141a may include a device that combines multiple sensors to measure and track the movement and orientation of the UE 100 in space. It is commonly used in various applications such as navigation systems, robotics, and virtual reality. The IMU 141a includes several sensors, including the accelerometer sensor 141b, the gyro sensor 141c, and the magnetometer sensor 141d. Each sensor serves a specific purpose in determining the position, movement, and environmental factors related to the UE 100 being tracked.

For example, the accelerometer sensor 141b may be configured to measure the acceleration force acting on the UE 100, allowing us to determine its position in space and monitor its movement. The gyro sensor 141c may be configured to measure and maintain an orientation and angular velocity of the UE 100, providing information about its direction of rotation, rotation angle, and vibration. The magnetometer sensor 141d may be configured to measure a density of magnetic flux, which helps determine the direction, strength, or changes in the magnetic field at a specific location. This information can be useful in various applications, such as compass navigation or detecting magnetic anomalies.

The GPS sensor 141e may be configured to provide real-time location information of the UE 100. The GPS sensor 141e may be further configured to track a movement of the UE 100 and also enables additional functionalities like finding the nearby temperature of an area.

The temperature and humidity sensor 141f may be configured to collect real-time data on temperature and humidity levels. These measurements are important because they can have an impact on various aspects of radio signal propagation and communication. The temperature and humidity sensor 141f gathers temperature data, represented as {t₁, t₂, . . . , t_{P}}, where tₚ represents the temperature level at a specific time (e.g., throughout the day, month, or year). Changes in temperature affect the density of the atmosphere, which in turn affects the scattering and fading of radio signals. By monitoring temperature variations, the AI module 143 may better understand how these factors impact signal quality. Similarly, the temperature and humidity sensor 141f may be configured to collect real-time humidity data, denoted as {u₁, u₂, . . . , u_{H}}, where u_{H} represents the humidity level at a specific time. Humidity also plays a role in signal propagation, influencing scattering and fading effects. By monitoring humidity levels, the AI module 143 may gain insights into how these factors affect parameters such as RSSI and packet transmission. High temperatures can lead to a decrease in received signal strength and an increase in packet loss or corruption, especially for nodes (e.g., UE 100) located at the edge of the communication range. Therefore, understanding temperature and humidity is desirable for maintaining reliable communication. Both temperature and humidity data obtained from the user equipment (UE) location serve as important inputs to the AI module 143 for further analysis and decision-making processes. By considering these factors, the AI module 143 may optimize communication systems and ensure efficient signal transmission in various environments.

The weather monitoring sensor 141g may be configured to collect weather data, as weather conditions have a significant impact on the CSI of the wireless channel. One particular weather element that affects wireless communication is rain, which can absorb the power of radio signals transmitted over certain frequency bands. When it comes to cellular networks, any water present in the atmosphere between the UE 100 and the network device can interfere with radio waves. This interference caused by rain, snow, fog, clouds, and high humidity can result in a drop in cell reception quality. Therefore, it is desirable to monitor the surrounding weather conditions to ensure optimal signal strength and reliability.

The weather monitoring sensor 141g may be configured to categorize the weather into different categories, such as sun, sun with clouds, cloud cover, light rain, medium rain, heavy rain, light snow, medium snow, and heavy snow. These categories serve as important inputs to the AI module 143 for measuring the CSI feedback, which is an important parameter for assessing the quality of the wireless channel. To obtain accurate and up-to-date weather information, the weather monitoring sensor 141g may rely on data from nearby weather stations. By taking into account the weather category and integrating this data into the CSI feedback measurement, the AI module 143 may gain a deeper understanding of how weather conditions affect wireless signal transmission and reception. This knowledge enables the AI module 143 to effectively optimize communication systems in different weather scenarios, leading to improved performance and reliability.

In various embodiments, the RF module 142 may include a RAN/physical layer data collection unit 142a and a measure unit 142b.

In various embodiments, the RAN/physical layer data collection unit 142a is associated with a Physical layer (PHY) of the wireless communication system. The PHY layer is responsible for transmitting data bits from one device to another device over a physical medium. The main functions of the PHY layer may include:
a. Maintaining data rate: The PHY layer ensures that the data is transmitted at the specified rate, allowing for efficient communication between devices.
b. Synchronization of Bits: The PHY layer synchronizes the bits being transmitted to ensure accurate and reliable data transfer.
c. Managing physical topology: The PHY layer helps in establishing and managing the physical configuration of the network, enabling point-to-point and point-to-multiple configurations.
d. Modulation: The PHY layer performs modulation, which is the process of converting data into radio waves that can be transmitted over the air.

Additionally, the PHY layer can handle multiple channels, such as Synchronization Signal Block (SSB), Channel State Information Reference Signal (CSI-RS), Sounding Reference Signal (SRS), Physical Downlink Control Channel (PDCCH), Physical Downlink Shared Channel (PDSCH), Physical Uplink Shared Channel (PUSCH), and Physical Uplink Control Channel (PUCCH). These channels play specific roles in the transmission and reception of data within the wireless communication system. In other words, the RAN/physical layer data collection unit 142a works in conjunction with the PHY layer to ensure efficient and reliable transmission of data over the physical medium, contributing to the smooth operation of the wireless communication system.

In various embodiments, the measure unit 142b may be configured to execute one or more measurement processes, wherein the network device (e.g., base station, gNB, etc.) requests the UE 100 to measure a radio channel state and provide a report to the network device. The UE 100 receives requests from the network device for the RRM measurements, the MDT measurements, the velocity, the position, and the CSI RS. The network device utilizes the CQI report to estimate the MCS and throughput of the UE 100. where the CQI is calculated based on the downlink SINR value received on the UE 100.

In various embodiments, the measure unit 142b may process various types of CSI are used, including the CQI, the PMI, the CRI, the SSBRI, the LI, and the RI. The periodicity in the time domain can be categorized as periodic, aperiodic, or semi-persistent.

In various embodiments, the measure unit 142b may process on a report quantity in the RRC including configurations such as CRI-RI-PMI-CQI, CRI-RI-LI-PMI-CQI, CRI-RI-i1, CRI-RI-i1-CQI, CRI-RI-CQI, CRI-RSRP, SSB-index-RSRP, CRI-SINR, and SSB-index-SINR. RRC Configuration is used to configure the CSI Report and includes parameters such as CSI-RS Resource Mapping, CSI-IM Resource, CSI-SemiPersistentOnPUSCH-TriggerStateList, CSI-AperiodicTriggerStateList, CSI ResourceConfig, and CSI-ReportConfig.

In various embodiments, the measure unit 142b may utilize a CSI report framework including two major parts: configurations and triggering states associated with a specific configuration.
a. Trigger states:
   i. Periodic: The UE 100 reports CQI periodically at intervals defined by the network device, as specified by the RRC.
   ii. Aperiodic: The CQI is transmitted by a special trigger from the network device, such as DCIO or RACH response.
   iii. Semi-Persistent: The semi-persistent can be considered a combination of the periodic and the aperiodic. The first cycle is similar to aperiodic reporting, but once triggered, CSI RS transmission and CSI report occur periodically.
b. Configuration: Resource configure ID physical layer configuration, resources bandwidth part, report measuring a specific BWP from the total spectrum bandwidth.

In various embodiments, the periodic and the aperiodic may utilize various physical channels, for example, as described in Table-2 below.

TABLE 2

| CSI report | |
|---|---|
| type | Physical Channel |
| Periodic | PUCCH: When no PUSCH is scheduled at the CSI report subframe. |
| | PUSCH: When PUSCH is scheduled at the CSI report subframe and |
| | Simultaneous PUCCH and PUSCH are not enabled. |
| Aperiodic | PUSCH only |

In various embodiments, the measure unit 142b is configured to execute one or more measurement processes, for example, the CSI report configuration/CSI reporting mechanism. The CSI report configuration may provide valuable insights into the quality and characteristics of the wireless channel. This CSI report configuration information is essential for the network device to optimize its resource allocation and enhance system performance. The RRC message carries the necessary parameters to configure the CSI reporting mechanism (e.g., the CQI, the PMI, the CRI, the SSBRI, the LI, and the RI). Within the context of CQI, there are two types of CQI configurations specifically related to:
a. Wideband CQI: This type of CQI offers an assessment of the overall channel quality across a wide frequency band.
b. Subband CQI: This type of CQI divides the frequency band into smaller subbands and provides separate channel quality measurements for each subband. Subband CQI can be configured in two different ways:
   i. UE selected: The UE 100 independently selects the subbands for which it will report the CQI.
   ii. Higher layer configured: The network device configures specific subbands for the UE 100 to report the CQI.

These various configurations provide flexibility in generating and transmitting CSI reports, allowing for efficient utilization of radio resources and improved performance.

In various embodiments, the measure unit 142b is configured to execute one or more measurement processes, for example, the SINR.

In existing wireless communication systems, the SINR is a metric that represents the ratio of the received signal level to the combined interference and noise level. The 3GPP specification (3GPP 38.214 Release 17) does not explicitly include the SINR parameter, and it is not sent back to the network device by the UE 100. Instead, the SINR is measured and utilized solely within the UE 100. The SINR is a useful metric for expressing the relationship between radio conditions and throughput. It can be employed, for example, in calculating the CQI value. The specific implementation of SINR measurement may vary among different manufacturers, as it is up to them to decide how to implement this measurement. Mathematically, the SINR is calculated as the power of the usable signal divided by the sum of the interference power and the noise power. The power of usable signals is denoted as “S”, interference power as “I”, and background noise power as “N”. As the distance between the UE 100 and the network device (e.g., gNB, eNodeB) increases, the SINR tends to decrease. Based on the UE's position and CQI (SINR), the network device allocates resources such as MCS and modulation to the UE 100. If there is more interference due to nearby towers (network devices) or a high concentration of devices in a specific area, the SINR value will decrease.

To report the SINR value to the network device, the measure unit 142b may map SINR values to CQI codes, for example, as described in Table-3 below.

TABLE 3

| SINR [dB] | CQI Code |
|---|---|
| −10 | 0 |
| −6.7 | 1 |
| −4.7 | 2 |
| −2.3 | 3 |
| 0.2 | 4 |
| 2.4 | 5 |
| 4.3 | 6 |
| 5.9 | 7 |
| 8.7 | 8 |
| 10.3 | 9 |
| 11.7 | 10 |
| 14.1 | 11 |
| 16.3 | 12 |
| 18.7 | 13 |
| 21 | 14 |
| 22.7 | 15 |

The measure unit 142b may utilize a mapping function, which takes into account the SINR values across all layers (corresponding to the reported PMI) and assigns a CQI value to each codeword. The mapping function compares the SINR of each codeword with predefined SINR thresholds from a table and selects the CQI value that corresponds to the maximum SINR below the codeword's SINR. The mapping function sets the CQI value in such a way that the Block Error Rate (BLER) is less than or equal to 0.1 when operating at SINR i. If a CQI index of 1 does not satisfy the BLER condition, then the function sets the CQI index to 0. Further, the measure unit 142b is configured to share information associated with the SINR/CQI value to the AI module 143 via the RAN/physical layer data collection unit 142a for training purposes 143a.

The AI module 143 may apply the generated CSI feedback to perform model inference with potential adjustments of one or more wireless communication parameters for enhancing the performance of the UE 100. Further, the AI module 143 may determine the CQI based on the generated CSI feedback and the configured measurement process. Furthermore, the AI module 143 may apply the potential adjustments of the one or more wireless communication parameters of the UE 100 to enhance the performance of the UE 100, based on the determined CQI and the plurality of determined physical characteristics, as described in greater detail below with reference to FIG. 4, and FIG. 5.

In other words, the AI module 143 may employ advanced mechanisms and computational techniques to analyze and process various measurements and one or more wireless communication parameters related to the channel state, such as signal strength, interference levels, and quality indicators (e.g., CQI). The AI module 143 extracts valuable insights from the collected data (e.g., the plurality of physical characteristics), generating accurate CSI feedback that provides crucial information about the current channel conditions. Additionally, the AI module 143 may generate predicted CSI image information, which visually represents the expected channel state in the future. This process demonstrates the UE's ability to leverage AI capabilities to enhance its understanding of the wireless communication environment. The AI mechanisms enable informed decisions and predictions based on analyzed data, improving performance, resource allocation, and user experience in the wireless communication systems.

FIG. 3C is a signal flow diagram 300 illustrating example measurement processes performed by the UE 100 to enhance the performance, according to various embodiments.

At step-301, the UE 100 receives information (measurement configuration) from the ngRAN-1 200 regarding the measurements it needs to perform. This information includes various types of measurements such as the RRM measurements, the MDT measurements, the velocity, the position, and the CSI-RS. At step-302, upon receiving the measurement configuration information, the UE 100 starts one or more measurement processes as instructed. These one or more measurement processes involve collecting data related to the RRM measurements, the MDT measurements, the velocity, the position, and the CSI feedback.

At step-303, instead of sending the measurement report to the ngRAN-1 200 as per existing wireless communication systems (refer FIG. 1), the UE 100 receives input data from the ngRAN-1 200 for training purposes. This input data is used to improve the performance of the AI module 143 associated with the UE 100. At step-304 to step-308, the UE 100 trains the AI module 143 (e.g., model training 143a), as described in greater detail with reference to FIG. 3A, FIG. 3B, FIG. 4, and FIG. 5. This training process enhances the ability of the UE 100 to make accurate predictions and decisions for adjustments of the one or more wireless communication parameters. At step-305, the UE 100 continuously determines the plurality of physical characteristics associated with the UE 100 for at least one of the indoor environment and the outdoor environment. At step-306 to step-308, the UE 100 performs the one or more actions and model inferences. These actions and inferences are related to various tasks such as load balancing prediction, network energy saving, mobility/handover management, and resource allocation for optimizing network performance. At step-309, the UE 100 sends the measurement report to the ngRAN-1 200. The measurement report includes important parameters such as the RSRP, the RSRQ, and the SINR for both the serving cell and neighboring cells. Additionally, the report may also include velocity, position, and in-beam level+CSI Feedback.

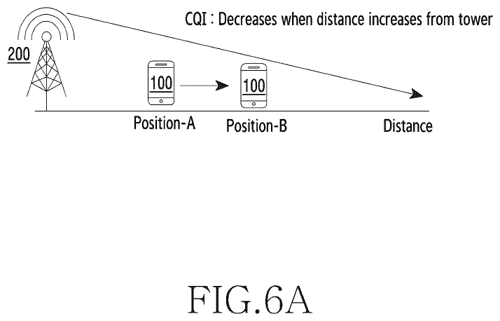

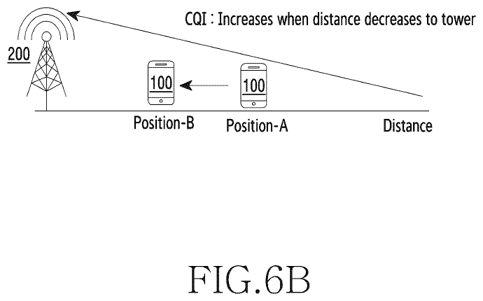

The signal flow diagram 300 illustrating the disclosed method offers numerous advantages compared to the existing wireless communication systems. One notable advantage is that the measurement processes are conducted at the UE 100 level rather than at the base station (e.g., ngRAN-1 200) or operator level. This method reduces the time required for measurements, minimizes and/or reduces the need for extensive signal processing, decreases overhead, and conserves resources. Additionally, the disclosed method improves a call quality (e.g., voice call, video call, etc.) of the UE 100. Consequently, it leads to higher power efficiency and greater network capacity. Moreover, this method enables real-time decision-making for the UE 100, even when it is in motion within indoor or outdoor environments, as described in greater detail below with reference to FIG. 6A and FIG. 6B.

FIG. 4 is a diagram illustrating an example scenario where the AI module 143 of the UE 100 performs one or more operations for generating CSI feedback and/or predicted CSI image information based on the configured measurement process and the characteristic of at least one wireless communication channel, according to various embodiments.

In various embodiments, the AI module 143 may be trained to generate the CSI feedback based on at least one of historical CSI image information, predicted CSI image information, live frequency data, the plurality of determined physical characteristics, and the configured measurement process.

Here, the frequency data is preprocessed and transformed into CSI information images. Location-based earlier predicted CSI images may be used to train the AI module 143. The plurality of physical characteristics/physical parameters (e.g., temperature, weather, humidity) effects as explained earlier may be used to train the AI module 143 with historical data/historical CSI image information. CSI image is created considering physical layer parameters, Since CSI image is 2D (m×m) and filter used of size (n×n). Then, the output of the convolutional layer will be (m−n+1)×(m−n+1), this non-linearity of each output neuron is calculated, as shown in equation-1.

$${x}_{i j}^{l} = {\sum }_{a = 0}^{m - 1} {\sum }_{b = 0}^{m - 1} {w}_{a b} {y}_{( i + a ) ( j + b )}^{l - 1} \cdot {y}_{i j}^{l} = σ ( {x}_{i j}^{l} ) \qquad ( 1 )$$

The AI module 143 may execute multiple steps to generate the predicted CSI image information, which are given below. The AI module 143 is configured to extract the one or more frequency representative vectors and one or more state representative matrices from the historical CSI image information, where the CSI image is fed into the CNN network. The AI module 143 is further configured to generate the one or more state-predicted vectors from the one or more state representative matrix, which is nothing but predicted CSI image information. The AI module 143 is further configured to determine the CSI feedback based on the one or more generated state-predicted vectors, where the AI module 143 is trained with a massive volume of the historical CSI image information to capture a sequential pattern of the CSI feedback over time by utilizing, for example, a stochastic gradient descent mechanism based on backpropagation, as shown in equation-2.

$$\frac{\partial E}{\partial {w}_{a b}} = {\sum }_{i = 0}^{N - m} {\sum }_{j = 0}^{N - m} \frac{\partial E}{\partial {x}_{ij}^{l}} \frac{\partial {x}_{ij}^{l}}{\partial {w}_{a b}} = {\sum }_{i = 0}^{N - m} {\sum }_{j = 0}^{N - m} \frac{\partial E}{\partial {x}_{ij}^{l}} {y}_{( i + a ) ( j + b )}^{l - 1} \qquad ( 2 )$$

FIG. 5 is a diagram illustrating an example scenario where the AI module 143 of the UE 100 performs one or more operations for applying the generated CSI feedback to perform model inference with potential adjustments of one or more wireless communication parameters for enhancing the performance of the UE 100, according to various embodiments.

At step 501, the UE 100 determines the plurality of physical characteristics associated with the UE 100 for at least one of the indoor environment and the outdoor environment and generates the CQI values. These determined plurality of physical characteristics serve as the training data for the AI module 143 (e.g., model training 143a). At step 502, once the AI module 143 is trained, the generated CQI values are mapped to a knowledge base that contains rules. This mapping process enables efficient inference. At step 503, the inference efficiency is determined by comparing the predicted efficiency of higher layers (such as the base station) with the inferred efficiency from the knowledge base. Then, an inference engine 143b of the AI module 143 generates the reward based on this comparison. At step 504, the reward is applied to the reward function, which facilitates comparison and learning to predict the best potential output.

In various embodiments, the AI module 143 may perform the model inference using a deep reinforcement learning mechanism with the reward function by performing one or more of the following steps. The AI module 143 may map the determined CQI to a knowledge base that contains mapping rules and provides the inference efficiency. The AI module 143 may generate the reward based on the inference efficiency. The AI module 143 may apply the reward to the reward function for comparison and learning, wherein the reward function is utilized to predict the one or more wireless communication parameters.

For example, consider a scenario where the UE 100 collects location and orientation measurements in the indoor environment. These measurements are used to train the AI module 143 (e.g., model training 143a) that predicts the CQI values. Once the AI module 143 is trained, the generated CQI values are mapped to the knowledge base that contains rules for efficient inference. During inference, the predicted efficiency of the higher layers, such as the base station, is compared with the inferred efficiency from the knowledge base. Based on this comparison, the reward is generated. The reward is then applied to the reward function, allowing for comparison, and learning to predict the best potential output.

In various embodiments, the inference engine 143b may utilize a bellman equation to determine the reward for a particular CQI, as shown in equation-3.

$$New CQI ( S , A ) = Current ( S , A ) + α [ R ( S , A ) + βMax {CQI}^{′} ( {S}^{′} , {A}^{′} ) - CQI ( S , A ) ] \qquad ( 3 )$$

α: To determine the next predicted CQI state that is suitable for the environment; and
β: To determine the difference between the current output and the predicted to determine the next possible best potential adjustment.

FIG. 6A is a diagram illustrating an example scenario in which the UE 100 sends a measurement report to a base station while in motion by utilizing the parameter adjustment module 140 of the UE 100, according to various embodiments.

Consider a scenario where the UE 100 starts moving away from the connected base station 200. As the distance between the UE 100 and the base station 200 increases, the SINR value decreases. Consequently, the CSI feedback value, specifically the CQI, also reduces with increasing distance. In the existing wireless communication systems (refer FIG. 2A), the problem arises when the UE 100 moves from position-A to position-B, the network conditions become even worse, the connected base station can allocate resources to the UE 100 based on outdated CSI feedback from position-A, which may refer, for example, to the UE's experience deteriorating. While according to the disclosed method, the UE 100 has the capability to predict the upcoming situation at a nearby position-B while it is located at position-A. Based on this prediction, the UE 100 sends an appropriate CQI value to the base station 200.

As a result, the disclosed method offers several advantages. Firstly, the disclosed method allows for efficient utilization of network resources, as the UE 100 can proactively communicate the anticipated channel conditions to the base station 200. This enables the base station 200 to allocate resources more effectively based on the predicted situation at position-B. Additionally, the disclosed method helps in balancing the performance of the UE 100. By providing accurate CQI information in advance, the UE 100 can ensure that the base station 200 optimally adapts its transmission parameters and resource allocation to maintain a balanced performance for the UE 100. Additionally, the disclosed method improves the call quality (e.g., voice call, video call, etc.) of the UE 100. Overall, the disclosed method enhances network efficiency, saves network resources, and improves the performance of the UE 100 in the wireless communication systems.

FIG. 6B is a diagram illustrating an example scenario in which the UE 100 sends the measurement report to the base station while in motion by utilizing the parameter adjustment module 140 of the UE 100, according to various embodiments.

Consider a scenario where the UE 100 starts moving towards the connected base station 200. As the distance between the UE 100 and the base station 200 decreases, the SINR value increases. Consequently, the CSI feedback value, specifically the CQI, also increases with decreasing distance. In the existing wireless communication systems (refer FIG. 2B), the problem arises when the UE 100 moves from position-A to position-B, the network conditions become even better, the connected base station can allocate resources to the UE 100 based on outdated CSI feedback from position-A, which refers, for example, to the UE's experience deteriorating. While according to the disclosed method, the UE 100 has the capability to predict the upcoming situation at a nearby position-B while it is located at position-A. Based on this prediction, the UE 100 sends an appropriate CQI value to the base station 200.

As a result, the disclosed method offers several advantages. Firstly, the disclosed method allows for efficient utilization of network resources, as the UE 100 can proactively communicate the anticipated channel conditions to the base station 200. This enables the base station 200 to allocate resources more effectively based on the predicted situation at position-B. Additionally, the disclosed method helps in balancing the performance of the UE 100. By providing accurate CQI information in advance, the UE 100 can ensure that the base station 200 optimally adapts its transmission parameters and resource allocation to maintain a balanced performance for the UE 100. Additionally, the disclosed method improves the call quality (e.g., voice call, video call, etc.) of the UE 100. Overall, the disclosed method enhances network efficiency, saves network resources, and improves the performance of the UE 100 in the wireless communication systems.

In an example scenario, consider a situation where the user of the UE is on a call while using an elevator to travel from a top floor to a ground floor. As the user moves towards the ground floor, the quality of the signal decreases. This results in a decrease in the accuracy of the feedback provided by the UE regarding the CSI/CQI. In the existing wireless communication systems, when the user moves from one position to another position, such as from the top floor to the ground floor, the network conditions worsen. The base station 20, relying on outdated CSI feedback from the top floor, allocates resources to the existing UE 10 based on the outdated CSI feedback from the top floor, leading to a deteriorated user experience (e.g., degradation in call quality). However, with the disclosed method, the UE 100 has the ability to predict the upcoming situation associated with the ground floor (position-B) while still at the top floor (position-A). Using this prediction, the UE 100 sends an appropriate CQI value to the base station 200, improving the overall user experience (e.g., call quality).

In an example scenario, where the user works in an office building (position A) and lives in a residential area (position B). Every day, the user takes the same route from his/her office to home. With the existing wireless communication systems, the resources allocated to the existing UE 10 are based solely on the distance between the existing UE 10 and the base station 10 and the current CSI feedback mechanism. However, with the disclosed method, the user's device (e.g., UE 100) utilizes the AI module 143 to learn his/her route pattern. Based on this learning, the UE 100 modifies the CSI feedback it provides to the base station 200. As a result, the base station 200 can allocate resources more effectively to the UE 100, considering the specific route pattern the user follows daily. This leads to improved performance (e.g., call quality) and efficiency in terms of resource allocation for the UE 100.

In various embodiments, in the beginning, the UE 100 autonomously adjusts one or more wireless communication parameters when there is movement associated with the UE 100, based on the predicted CSI/CQI. Subsequently, the base station 200 adjusts its own parameters for allocating the resources to the UE 100 based on the predicted CSI report received from the UE 100, which is necessary because there is a significant variation in channel quality between the time when the base station 200 schedules data transmission and the time when the UE 100 measures CSI.

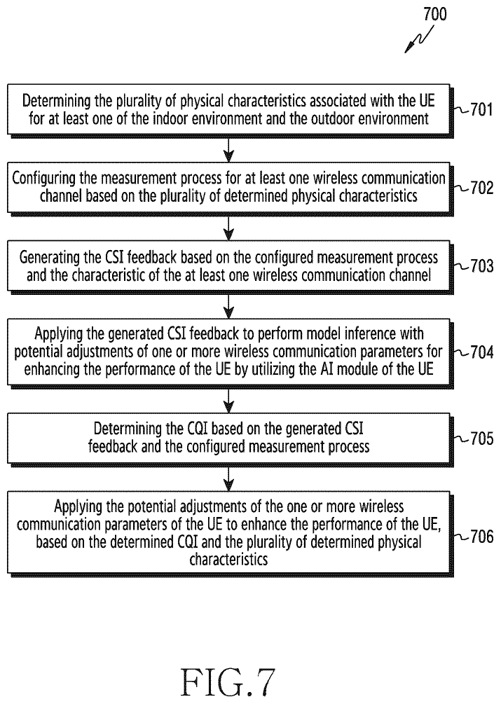

FIG. 7 is a flowchart illustrating an example method 700 for enhancing the performance of the UE 100 in the wireless communication system, according to various embodiments.

At step 701, the method 700 includes determining the plurality of physical characteristics associated with the UE 100 for at least one of the indoor environment and the outdoor environment, as described with reference to FIG. 3A, FIG. 3B, and FIG. 3C.

At step 702, the method 700 includes configuring the measurement process for at least one wireless communication channel based on the plurality of determined physical characteristics, as described with reference to FIG. 3A, FIG. 3B, and FIG. 3C.

At step 703, the method 700 includes generating the CSI feedback based on the configured measurement process and the characteristic of the at least one wireless communication channel, as described in with reference to FIG. 3A, FIG. 3B, FIG. 3C, and FIG. 4.

At step 704, the method 700 includes applying the generated CSI feedback to perform model inference with potential adjustments of one or more wireless communication parameters for enhancing the performance of the UE 100 by utilizing the AI module 143 of the UE 100 as described with reference to FIG. 3A, FIG. 3B, FIG. 3C, and FIG. 5.

At step 705, the method 700 includes determining the CQI based on the generated CSI feedback and the configured measurement process, as described with reference to FIG. 3A, FIG. 3B, FIG. 3C, and FIG. 5.

At step 706, the method 700 includes applying the potential adjustments of the one or more wireless communication parameters of the UE 100 to enhance the performance of the UE 100, based on the determined CQI and the plurality of determined physical characteristics, as described with reference to FIG. 3A, FIG. 3B, FIG. 3C, FIG. 6A and FIG. 6B.

The various actions, acts, blocks, steps, or the like in the flowchart may be performed in the order presented, in a different order, or simultaneously. Further, in various embodiments, some of the actions, acts, blocks, steps, or the like may be omitted, added, modified, skipped, or the like without departing from the scope of the invention.

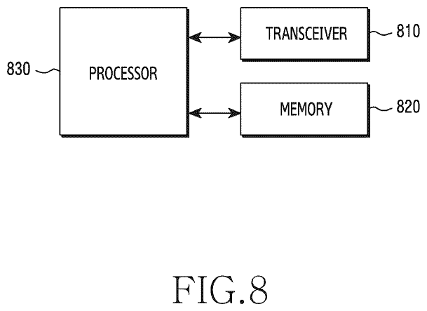

FIG. 8 is a block diagram illustrating an example configuration of a UE according to various embodiments.

As shown in FIG. 8, the UE according to an embodiment may include a transceiver 810, a memory 820, and a processor (e.g., including processing circuitry) 830. The transceiver 810, the memory 820, and the processor 830 of the UE may operate according to a communication method of the UE described above. However, the components of the UE are not limited thereto. For example, the UE may include more or fewer components than those described above. In addition, the processor 830, the transceiver 810, and the memory 820 may be implemented as a single chip. Also, the processor 830 may include at least one processor. Furthermore, the UE of FIG. 8 corresponds to the UE 10 of FIG. 1 to 2B or UE 100 of FIG. 3 to 6B.

The transceiver 810 may collectively refer to a UE receiver and a UE transmitter, and may transmit/receive a signal to/from a base station or a network entity. The signal transmitted or received to or from the base station or a network entity may include control information and data. The transceiver 810 may include a RF transmitter for up-converting and amplifying a frequency of a transmitted signal, and a RF receiver for amplifying low-noise and down-converting a frequency of a received signal. However, this is only an example of the transceiver 810 and components of the transceiver 810 are not limited to the RF transmitter and the RF receiver.

The transceiver 810 may receive and output, to the processor 830, a signal through a wireless channel, and transmit a signal output from the processor 830 through the wireless channel.

The memory 820 may store a program and data required for operations of the UE. Also, the memory 820 may store control information or data included in a signal obtained by the UE. The memory 820 may be a storage medium, such as read-only memory (ROM), random access memory (RAM), a hard disk, a CD-ROM, and a DVD, or a combination of storage media.

The processor 830 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 830 may, for example, control a series of processes such that the UE operates as described above. For example, the transceiver 810 may receive a data signal including a control signal transmitted by the base station or the network entity, and the processor 830 may determine a result of receiving the control signal and the data signal transmitted by the base station or the network entity.

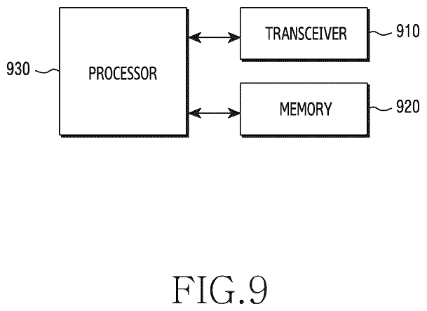

FIG. 9 is a block diagram illustrating an example configuration of a base station according to various embodiments.

As shown in FIG. 9, the base station according to an embodiment may include a transceiver 910, a memory 920, and a processor (e.g., including processing circuitry) 930. The transceiver 910, the memory 920, and the processor 930 of the base station may operate according to a communication method of the base station described above. However, the components of the base station are not limited thereto. For example, the base station may include more or fewer components than those described above. In addition, the processor 930, the transceiver 910, and the memory 920 may be implemented as a single chip. Also, the processor 930 may include at least one processor. Furthermore, the base station of FIG. 9 corresponds to the ngRAN-1 20, the ngRAN-2 30 of FIG. 1 to 2B or ngRAN-1 200 of FIG. 3C or 6A-6B.

The transceiver 910 may collectively refer to a base station receiver and a base station transmitter, and may transmit/receive a signal to/from a terminal (UE) or a network entity. The signal transmitted or received to or from the terminal or a network entity may include control information and data. The transceiver 910 may include a RF transmitter for up-converting and amplifying a frequency of a transmitted signal, and a RF receiver for amplifying low-noise and down-converting a frequency of a received signal. However, this is only an example of the transceiver 910 and components of the transceiver 910 are not limited to the RF transmitter and the RF receiver.

The transceiver 910 may receive and output, to the processor 930, a signal through a wireless channel, and transmit a signal output from the processor 930 through the wireless channel.

The memory 920 may store a program and data required for operations of the base station. Also, the memory 920 may store control information or data included in a signal obtained by the base station. The memory 920 may be a storage medium, such as read-only memory (ROM), random access memory (RAM), a hard disk, a CD-ROM, and a DVD, or a combination of storage media.

The processor 930 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 930 may, for example, control a series of processes such that the base station operates as described above. For example, the transceiver 910 may receive a data signal including a control signal transmitted by the terminal, and the processor 930 may determine a result of receiving the control signal and the data signal transmitted by the terminal.

The methods according to the embodiments described in the claims or the detailed description of the present disclosure may be implemented in hardware, software, or a combination of hardware and software.

When the electrical structures and methods are implemented in software, a computer-readable recording medium having one or more programs (software modules) recorded thereon may be provided. The one or more programs recorded on the computer-readable recording medium are configured to be executable by one or more processors in an electronic device. The one or more programs include instructions to execute the methods according to the embodiments described in the claims or the detailed description of the present disclosure.

The programs (e.g., software modules or software) may be stored in random access memory (RAM), non-volatile memory including flash memory, read-only memory (ROM), electrically erasable programmable read-only memory (EEPROM), a magnetic disc storage device, compact disc-ROM (CD-ROM), a digital versatile disc (DVD), another type of optical storage device, or a magnetic cassette. Alternatively, the programs may be stored in a memory system including a combination of some or all of the above-mentioned memory devices. In addition, each memory device may be included by a plural number.

The programs may also be stored in an attachable storage device which is accessible through a communication network such as the Internet, an intranet, a local area network (LAN), a wireless LAN (WLAN), or a storage area network (SAN), or a combination thereof. The storage device may be connected through an external port to an apparatus according the embodiments of the present disclosure. Another storage device on the communication network may also be connected to the apparatus performing the embodiments of the present disclosure.

In the present disclosure, elements included in the present disclosure are expressed in a singular or plural form according to the embodiments. However, the singular or plural form is appropriately selected for convenience of explanation and the present disclosure is not limited thereto. As such, an element expressed in a plural form may also be configured as a single element, and an element expressed in a singular form may also be configured as plural elements.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this disclosure can be used, these features can be used in any other suitable system.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In various embodiments, the described elements may be configured to reside on a tangible, persistent, addressable storage medium and may be configured to execute on one or more processors. These functional elements may in various embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this disclosure, the term “comprising” or “comprises” may refer, for example, to including the component(s) specified but not to the exclusion of the presence of others.

All of the features disclosed herein (including any accompanying claims, abstract and drawings), and/or all of the steps of any method or process so disclosed, may be combined in any combination, except combinations where at least some of such features and/or steps are mutually exclusive.

Each feature disclosed herein (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The disclosure is not restricted to the details of the foregoing example embodiment(s). The disclosure extends to any novel one, or any novel combination, of the features disclosed herein (including any accompanying claims, abstract and drawings), or to any novel one, or any novel combination, of the steps of any method or process so disclosed.

Unless otherwise defined, all technical and scientific terms used herein have the same meaning as commonly understood by one ordinary skilled in the art to which this invention belongs. The system, methods, and examples provided herein are illustrative only and not intended to be limiting.

While specific language has been used to describe the present subject matter, any limitations arising on account thereto, are not intended. As would be apparent to a person in the art, various working modifications may be made to the method to implement the inventive concept as taught herein. The drawings and the forgoing description give examples of embodiments. Those skilled in the art will appreciate that one or more of the described elements may well be combined into a single functional element. Certain elements may be split into multiple functional elements. Elements from one embodiment may be added to another embodiment.

The embodiments disclosed herein can be implemented using at least one hardware device and performing network management functions to control the elements.

The foregoing description of the various example embodiments will reveal the general nature of the embodiments herein wherein those skilled in the art, by applying current knowledge, readily modify and/or adapt for various applications such example embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of example embodiments, those skilled in the art will recognize that the embodiments herein can be practiced with modification within the scope of the embodiments as described herein.

What is claimed is:

1. A method performed by a terminal in a wireless communication system, the method comprising:
determining a plurality of physical characteristics associated with the terminal for at least one of an indoor environment and an outdoor environment;
configuring a measurement process for at least one wireless communication channel based on the plurality of determined physical characteristics;
generating a channel state information (CSI) feedback based on the configured measurement process and a characteristic of the at least one wireless communication channel; and
applying the generated CSI feedback to perform model inference with potential adjustments of one or more wireless communication parameters for utilizing an artificial intelligence (AI) module of the terminal.

2. The method of claim 1, comprising:
determining a channel quality indicator (CQI) based on the generated CSI feedback and the configured measurement process; and
applying the potential adjustments of the one or more wireless communication parameters of the terminal to enhance the performance of the terminal, based on the determined CQI and the plurality of determined physical characteristics.

3. The method of claim 1, wherein the one or more wireless communication parameters comprise an optimal transmission power, an optimal modulation and coding scheme (MCS), an optimal coding rate, scheduling of data packets, a transport block size (TBS), and a resource block (RB).

4. The method of claim 1, wherein the AI module is trained to generate the CSI feedback based on at least one of historical CSI image information, predicted CSI image information, live frequency data, the plurality of determined physical characteristics, and the configured measurement process.

5. The method of claim 4, wherein the predicted CSI image information is generated by:
extracting, by the AI module, one or more frequency representative vectors and one or more state representative matrices from the historical CSI image information;
generating, by the AI module, one or more state-predicted vectors from the one or more state representative matrix; and
determining, by the AI module, the CSI feedback based on the one or more generated state predicted vectors, wherein the AI module is trained with the historical CSI image information to capture a sequential pattern of the CSI feedback over time.

6. The method of claim 2, comprising:
performing the model inference using a deep reinforcement learning mechanism with a reward function comprises:
mapping the determined CQI to a knowledge base containing mapping rules and providing an inference efficiency;
generating a reward based on the inference efficiency; and
applying the reward to the reward function for comparison and learning, wherein the reward function is utilized to predict the one or more wireless communication parameters.

7. The method of claim 1, wherein the plurality of physical characteristics comprise at least one of a terminal distribution, a carrier frequency, a speed of the terminal, a location of the terminal, an orientation of the terminal, a movement of the terminal, and a channel quality indicator (CQI).

8. The method of claim 1, wherein the plurality of physical characteristics is determined by a sensor module of the terminal comprises at least one of an accelerometer sensor, a gyro sensor, a magnetometer sensor, a global positioning system (GPS) sensor, a temperature and humidity sensor, and a weather monitoring sensor.

9. The method of claim 1, wherein configuring the measurement process comprises:
receiving a request from a network device to perform one or more measurements associated with the at least one wireless communication channel, wherein the one or more measurements comprise at least one of a radio resource management (RRM) measurements, minimization of drive tests (MDT) measurements, a speed of the terminal, a position of the terminal, a channel state information reference signal (CSI RS), a CSI measurement, and a signal-to-interference-plus-noise ratio (SINR); and
transmitting a report associated with the one or more performed measurements to the network device.

10. The method of claim 1, wherein configuring the measurement process comprises:
receiving radio resource control (RRC) configuration information from the network device; and
configuring a CSI-reporting comprises a CSI-RS resource mapping, a CSI informational measurement resource, a CSI semi-persistent on physical uplink shared channel (PUSCH) trigger state list, a CSI aperiodic trigger state list, a CSI resource configuration, and a CSI report configuration.

11. A terminal in a wireless communication system, the terminal comprising:
a transceiver;
at least one processor; and
at least one memory storing instructions, when executed by the at least one processor, cause the terminal to:
determine a plurality of physical characteristics associated with the terminal for at least one of an indoor environment and an outdoor environment;
configure a measurement process for at least one wireless communication channel based on the plurality of determined physical characteristics;
generate a channel state information (CSI) feedback based on the configured measurement process and a characteristic of the at least one wireless communication channel; and
apply the generated CSI feedback to perform model inference with potential adjustments of one or more wireless communication parameters for utilizing an artificial intelligence (AI) module of the terminal.

12. The terminal of claim 11, wherein the at least one memory storing instructions, when executed by the at least one processor, further cause the terminal to:
determine a channel quality indicator (CQI) based on the generated CSI feedback and the configured measurement process; and
apply the potential adjustments of the one or more wireless communication parameters of the terminal to enhance the performance of the terminal, based on the determined CQI and the plurality of determined physical characteristics.

13. The terminal of claim 11, wherein the one or more wireless communication parameters comprise an optimal transmission power, an optimal modulation and coding scheme (MCS), an optimal coding rate, scheduling of data packets, a transport block size (TBS), and a Resource Block (RB).

14. The terminal of claim 11, wherein the AI module is trained to generate the CSI feedback based on at least one of historical CSI image information, predicted CSI image information, live frequency data, the plurality of determined physical characteristics, and the configured measurement process.

15. The terminal of claim 14, wherein the predicted CSI image information is generated by:
extracting one or more frequency representative vectors and one or more state representative matrices from the historical CSI image information;
generating one or more state-predicted vectors from the one or more state representative matrix; and
determining the CSI feedback based on the one or more generated state predicted vectors, wherein the AI module is trained with the historical CSI image information to capture a sequential pattern of the CSI feedback over time.

16. The terminal of claim 11, wherein the at least one memory storing instructions, when executed by the at least one processor, further cause the terminal to:
perform the model inference using a deep reinforcement learning mechanism with a reward function comprises:
mapping the determined CQI to a knowledge base containing mapping rules and providing an inference efficiency;
generating a reward based on the inference efficiency; and
applying the reward to the reward function for comparison and learning, wherein the reward function is utilized to predict the one or more wireless communication parameters.

17. The terminal of claim 11, wherein the plurality of physical characteristics comprise at least one of a terminal distribution, a carrier frequency, a speed of the terminal, a location of the terminal, an orientation of the terminal, a movement of the terminal, and a channel quality indicator (CQI).

18. The terminal of claim 11, wherein the plurality of physical characteristics is determined by a sensor module of the terminal comprises at least one of an accelerometer sensor, a gyro sensor, a magnetometer sensor, a global positioning system (GPS) sensor, a temperature and humidity sensor, and a weather monitoring sensor.

19. The terminal of claim 11, wherein the at least one memory storing instructions, when executed by the at least one processor, further cause the terminal to:
receive a request from a network device to perform one or more measurements associated with the at least one wireless communication channel, wherein the one or more measurements comprise at least one of a radio resource management (RRM) measurements, minimization of drive tests (MDT) measurements, a speed of the terminal, a position of the terminal, a channel state information reference signal (CSI RS), a CSI measurement, and a signal-to-interference-plus-noise ratio (SINR); and
transmit a report associated with the one or more performed measurements to the network device.

20. The terminal of claim 11, wherein the at least one memory storing instructions, when executed by the at least one processor, further cause the terminal to:
receive radio resource control (RRC) configuration information from the network device; and
configure a CSI-reporting comprises a CSI-RS resource mapping, a CSI informational measurement resource, a CSI semi-persistent on physical uplink shared channel (PUSCH) trigger state list, a CSI aperiodic trigger state list, a CSI resource configuration, and a CSI report configuration.
